(19) United States
(12) Patent Application Publication
(10) Pub. No.: US 2003/0207703 A1
(43) Pub. Date: Nov. 6, 2003

(54) Multi-purpose wireless communication device

(76) Inventors: Ruey-ming Liou, Taoyuan City (TW); Hsia-Ching Sung, Taipei (TW); Chih-chiang Lin, San Chung City (TW); Chin-Chin Yeh, Chidu chiu Keeiung (TW); Yee-Lok Wong, Taipei (TW)

Correspondence Address: RICHARD C. HIMELHOCH, 311 S. WACKER DRIVE, 53RD FLOOR, CHICAGO, IL, 60606-6622, US

(21) Appl. No.: 10/138,929

(22) Filed: May 3, 2002

(51) Int. Cl. H04B 1/38

(52) U.S. Cl. 455/575.2; 455/569.1; 455/557

(57) ABSTRACT

A multi-purpose wireless communication device. The device is in the form of an headset for wireless transmission of audio information. The device includes a connection for a U.S.B. port of a computer for wireless data communication. The device includes a case containing a circuit board, a headset, a retractable microphone, and a connection port. The circuit board includes an 8M bit memory partitioned into two 4M bit segments, and an integrated circuit control chip. The first segment of the memory is for use with the headset, and the second segment of the memory for wireless data communication when connected to a computer.

In one embodiment, the present invention is a wireless communication device comprising a headset having an receiver and a microphone, the headset further having a connector for connection to a first apparatus (such as a computer), an antenna, and a control circuit. The control circuit controls wireless audio transmissions when used in an audio transmission mode and controls wireless data transmissions when the headset is connected to the first apparatus. The control circuit comprises an integrated circuit control chip electronically coupled to a memory.

The memory is preferably one eight megabit chip which is divided into a first segment (the first 4 megabits) for use with audio transmissions (i.e., with the receiver and microphone), and a second segment (the second 4 megabits) for use with data transmissions. Alternatively, the integrated circuit control chip is electronically coupled to a first memory for use with audio transmissions and a second memory for use with data transmissions. When using a single eight megabit memory, the devise further comprises an address line for selecting the first segment or the second segment. When using a first memory and a second memory, a switch is provided to select or enable one memory for use with the control chip.

The connector connects the headset to the U.S.B. port of the computer through a cable. Alternatively, the connector can be configured to plug directly into the U.S.B. port. When connected to a computer the device can be used for wireless data transmission to other computers, or peripheral devices such as a printer. When used in the headset mode, the device provide wireless audio transmissions to a mobile phone (i.e., a cordless or cell), a stationary phone, or to another headset within the range of the device. Preferably the device uses Bluetooth™ technology for the wireless communication.

In another embodiment, a multi-purpose wireless communication device for wireless audio communication and wireless data communication comprises a headset having an antenna for wireless communication, the headset further having a connector for connection to a first apparatus (e.g., a computer) for effecting wireless communication between the first apparatus and a second apparatus (e.g., a printer).

The device further includes a control circuit located in a casing of the headset for controlling the wireless communication. Again, the control circuit includes an integrated circuit control chip connected by address and data lines to a memory chip. The memory chip is preferably partitioned into a first segment for use with wireless audio transmissions, and a second segment for use with data transmissions when the device is connected to the first apparatus. Alternatively, the control circuit includes an integrated circuit control chip connected by a first set of address and data lines to a first memory chip, and a second set of address and data lines to a second memory chip, wherein the first memory chip is for use with wireless audio communication, and the second memory chip is for use with wireless data communication when the device is connected to the first apparatus.

When using a single memory chip partitioned into a first and a second segment, one of the address lines determines which segment is used. Use of the connector may control setting the address line to the second segment which is responsible for facilitating wireless data transmission.

In yet another embodiment, a multi-purpose wireless communication device for alternate wireless audio communication and wireless data communication comprises a headset case housing an receiver, a microphone and an antenna, the headset case including a connector port for connection via a cable to a computer. Additionally, the headset case houses a control circuit having an integrated circuit control chip connected to flash memory by address and data lines, the flash memory containing information for use in wireless audio communication and wireless data communication. The device connects to a U.S.B. port in the computer and provides wireless communication between the computer and a peripheral device such as a printer.

The flash memory may include a first segment for use with audio communication when used as a headset, and a second segment for use with data communication from the computer. Alternatively, the flash memory may comprise a first flash memory chip for use with audio wireless transmissions, and a second flash memory chip for use with data wireless transmissions. In this instance, the address and data lines comprise a first set of address and data lines connecting the first memory chip to the integrated circuit control chip and a second set of address and data lines connecting the second memory chip to the integrated circuit control chip.

In yet a further embodiment, a multi-purpose wireless communication device comprises a headset having an receiver and a microphone, means for effecting wireless audio communication; means for connecting said head set to a first apparatus; and, means for effecting wireless communication between the first apparatus and a second apparatus. The first apparatus may be a computer and the second apparatus may be a printer. When used as a headset, the device may communicate with a mobile or stationary phone.

Further aspects of the invention are disclosed in the detailed description of the preferred embodiment, the drawings and the claims.

### BRIEF DESCRIPTION OF THE DRAWINGS

FIG. 1 is a schematic diagram of a logic control circuit for a wireless headset of the prior art;

FIG. 2 is a schematic diagram of a logic control circuit for a wireless data transmission system of the prior art;

FIG. 3 is a schematic diagram of a logic control circuit of a wireless device in accordance with the present invention containing two units of 4 megabit flash memory;

FIG. 4 is a another schematic diagram of a logic control circuit of a wireless device in accordance with the present invention containing two units of 4 megabit flash memory;

FIG. 5A is a perspective view of a wireless headset in accordance with the present invention with the microphone in a collapsed position;

FIG. 5B is a perspective view of a wireless headset of FIG. 5A with the microphone extended;

FIG. 5C is a another perspective view of a wireless headset of FIG. 5A with the microphone extended;

FIG. 6 is a schematic diagram of a preferred wireless device in accordance with the present invention with a single 8 megabit flash memory;

FIG. 7 is schematic diagram of another preferred wireless device in accordance with the present invention with a single megabit flash memory; and,

FIG. 8 is a control work flow diagram of a portion of the workflow associated with the present invention.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is a headset for wireless communication with a phone or another headset, that is capable of connecting to another apparatus (such as a computer), for effecting wireless data communication with a second apparatus (such as a printer). This device is preferably uses Bluetooth™ wireless technology. The Bluetooth™ wireless technology provides short range, wireless connectivity between common devices.

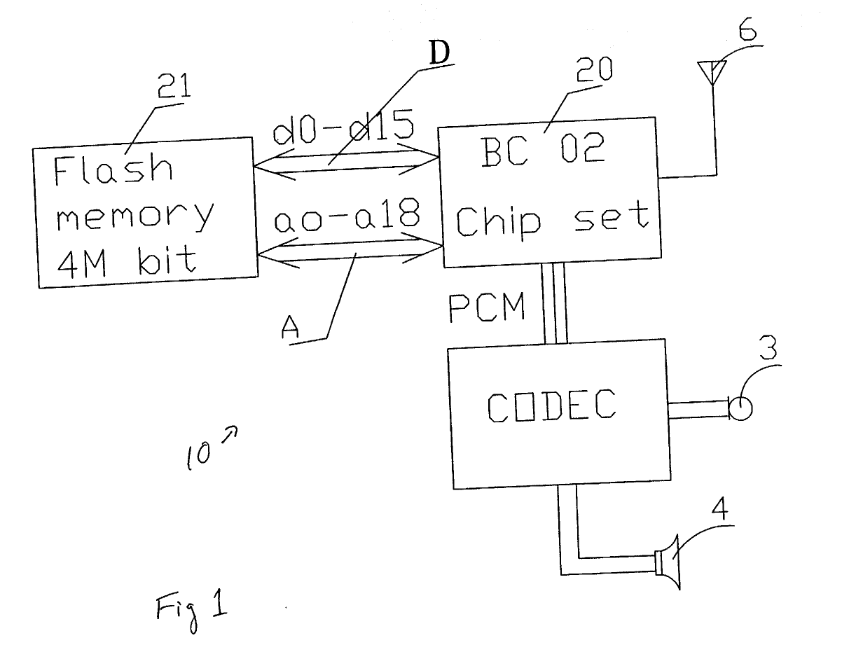

Prior to the present invention, wireless headsets using Bluetooth™ technology existed which communicated with mobile phones or other headsets. As shown in FIG. 1, such headsets 10 included an receiver 3, a microphone 4 and an antenna 6. Additionally, the headset included a control chip 20 which communicated via data lines (d0-d15) and address lines (a0-a18) to a four megabit flash memory 21. The control chip 20 and flash memory 21 were located on an electronic circuit board in a case (not shown) of the headset 10. The control chip 20 and flash memory 21 controlled the signals to and from the antenna 6 to allow for audio wireless transmissions using the headset 10.

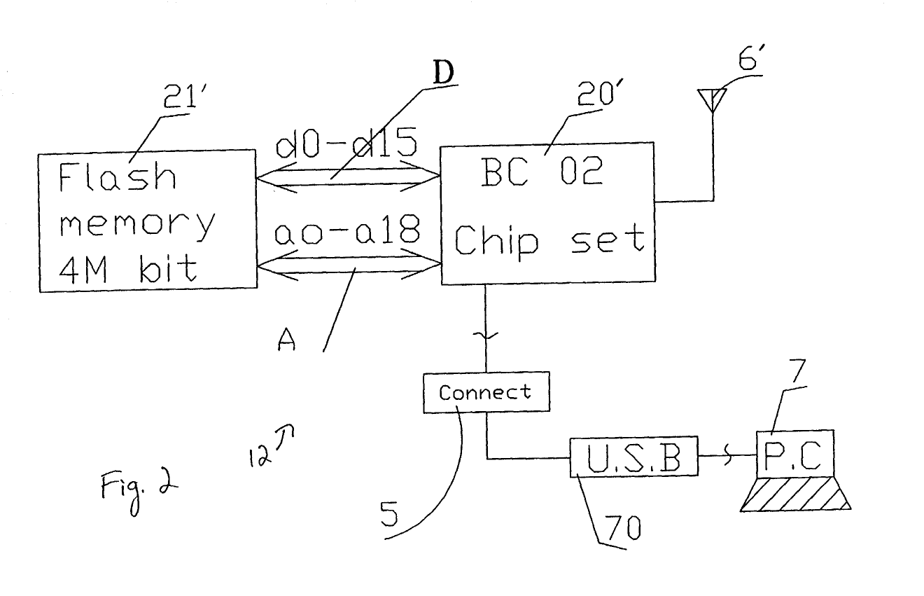

Another device 12 that existed prior to the present invention provided for wireless data communication between two apparatuses (that otherwise were not capable of wireless communication), such as a first computer and a second computer, or a first computer and a printer or other peripheral device. As illustrated in FIG. 2, the device 12 included a connect or connector 5 for connecting the device to a U.S.B. port 70 of a personal computer 7. The connector 5 could be a cable port in the device. Similar to the wireless headset, the device 12 included an antenna 6′, and a control chip 20′ coupled to a four megabit flash memory 21′ via data lines (d0-d15) and address lines (a0-a18). Again, the control chip 20′ and flash memory 21′ controlled wireless data transmissions to and from the personal computer.

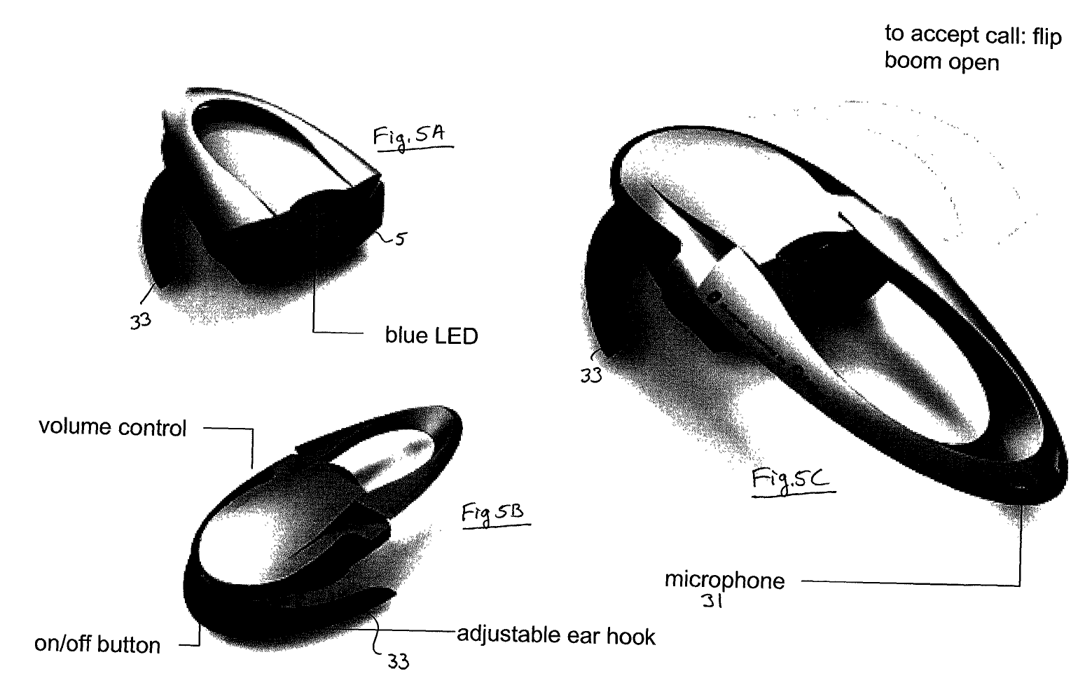

While both these prior devices 10 and 12 operated with similar logic, each was used only for a particular purpose or function. The present invention combines the functionality of these two prior devices into a single device. Preferably, the device of the present invention is in the form of an headset 16 as shown in FIGS. 5A-5C.

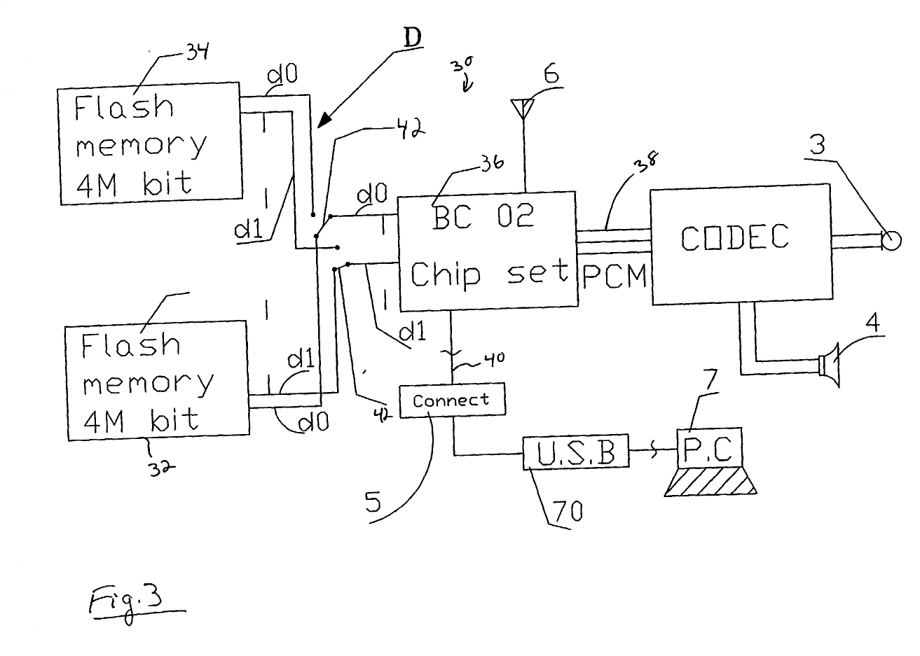

In one embodiment of the invention, illustrated graphically in FIG. 3, the headset 16 includes an receiver 3, a retractable microphone 4 and an antenna 6 as in a conventional wireless headset. However, the headset 16 is additionally provided with a connector 5 for connecting the headset to a the U.S.B. port 70 (preferably through a cable) of another apparatus, such as a personal computer 7, to function as wireless data link. The connector is preferably a port in the headset housing. Alternatively, the connector 5 could be in the form of a plug to connect the device directly to the U.S.B. port of the computer.

As shown in FIGS. 5B and 5C, the retractable microphone 4 includes a microphone 31 that can be extended when used as a headset. The headset also includes an adjustable ear hook 33 for holding the headset to the user's ear.

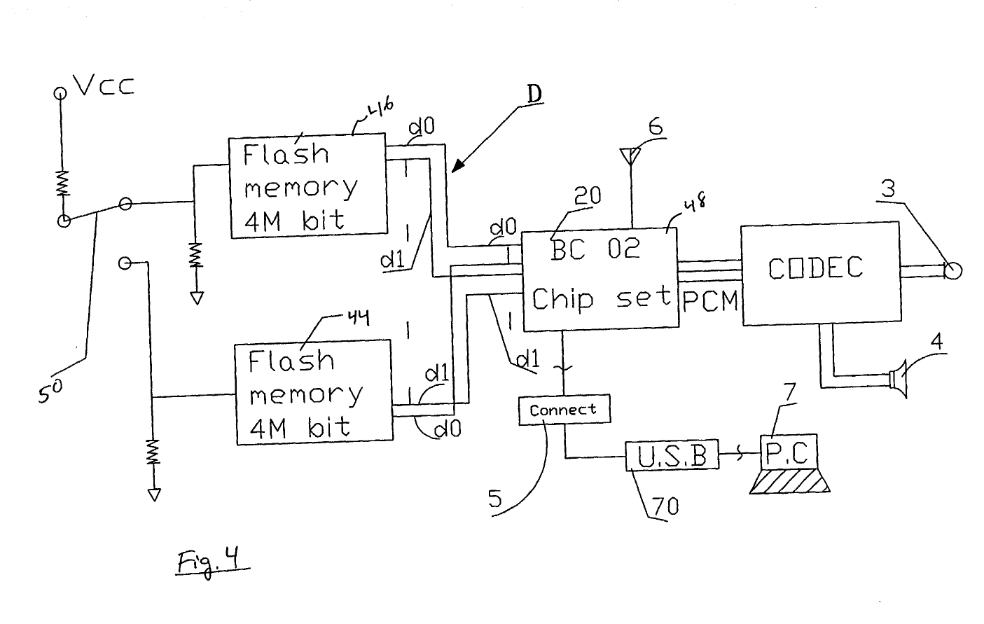

In order to provide for both audio transmissions (when used as in a wireless headset) or data transmissions (when used as a wireless data link), a control circuit 30 is housed in a casing (shown in FIGS. 5A-5C) of the headset 16. The control circuit includes an integrated circuit control chip set 36, a first four megabit flash memory 32 and a second four megabit flash memory 34. Both the first flash memory 32 and the second flash memory 34 are connected by data and address lines (d0, d1) to the integrated circuit control chip set 36. Only representative data and address lines are illustrated in FIG. 3 (and FIG. 4 discussed below). However, for practical operation, more than a dozen data and address lines, at a minimum, are typically required. The control chip set 36 includes features similar to those provided by a Bluetooth™ wireless transmission control chip.

As shown in FIG. 3, the control chip 36 is connected via lines 38 to the receiver 3 and microphone 4. The control chip 36 is also connected by line 40 to the connector 5.

The first flash memory 32 contains the programming or other functionality required for use with the control chip set 36 to facilitate audio transmissions, when the device is used as a headset. The second flash memory 34 contains programming or other functionality required for use with the control chip set 36 when the device is used as a data link connected to the U.S.B. port of another apparatus.

A switch 42 is provided to alternatively connect the data and address lines to either the first flash memory 32 or the second flash memory 34 to the control chip set 36, depending on which mode the device is to be used in. As shown in FIG. 2, the switch 42 completes either the set of data and address lines connecting the first flash memory 32 to the control chip set 36, or completes the set of data and address lines connecting the second flash memory 34 to the control chip. The set of address and data lines not completed are left as an open circuit.

A separate embodiment, also employing a first four megabit flash memory 44 and a second four megabit flash memory 46, is illustrated in FIG. 4. In this embodiment, each of the flash memories 44 and 46 include dedicated (i.e., complete) data and address lines (d0, d1) to a control chip 48. Again, only representative data and address lines are shown. In this embodiment however, a switch 50 is used to alternatively connect each flash memory 44,46 to a voltage V_{cc}. When connected to the voltage V_{cc}, the selected flash memory is enabled and can communicate with the control chip 48.

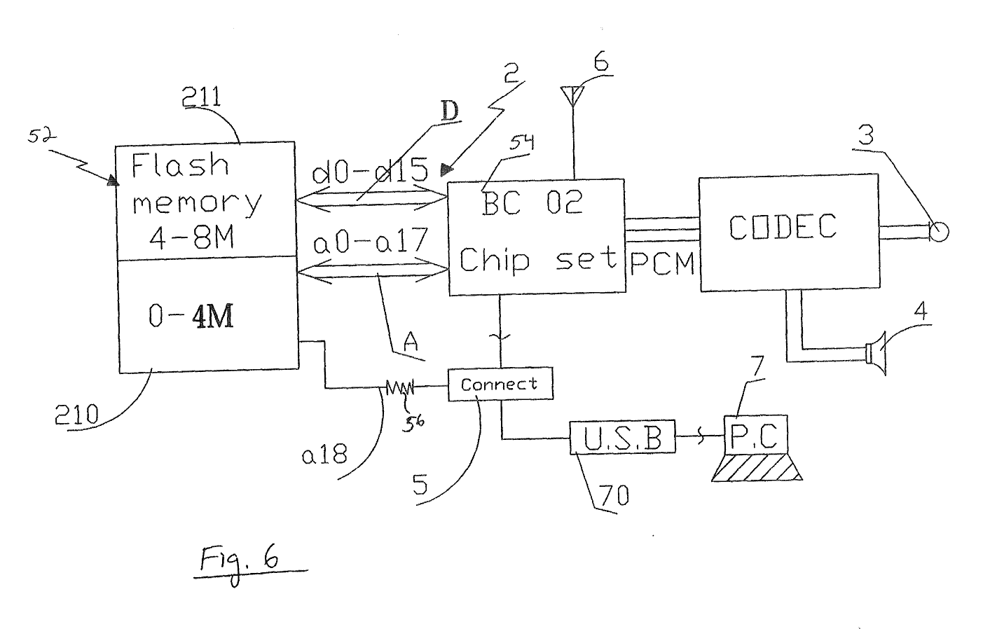

While the embodiments of FIGS. 3 and 4 combine the functionality of both wireless audio communication and wireless data communication into a single device, having two separate flash memories in one control circuit requires additional space to contain the second memory and the large number of data and address lines needed to connect each memory to the control chip. In an alternative embodiment shown in FIG. 6, a single eight megabit flash memory 52 is used with a control chip set 54, instead of two separate four megabit flash memories. Preferably, a BC02 (Blue Core 02) chip set produced by UK CSR (Cambridge Silicon Radio) can be applied as the control chip set.

The control chip set 54 communicates with the eight megabit flash memory 52 via sixteen data lines (d0-d15) and eighteen address lines (a0-a17). The eight megabit flash memory is partitioned into two work segments 210 and 211. A first work segment 211 is the first 4 megabits of the memory and a second work segment 211 is the second 4 megabits of the memory. In this application, the first 4 megabit segment 210 is assigned to facilitate functioning as a headset, and the second 4 megabit segment 211 is assigned to facilitate data transmission. In practice, both work segments 210 and 211 may be operated alternatively depending on the features and approaches desired by the user.

Switching between work segments is essentially done by one of the address lines (a18). Preferably, this address line (a18) is used to specify which work segment is used. In this regard a binary “0” (no current flowing through the line) is used for the first work segment 210, and a binary “1” (current flowing through the line) is used for the second work segment 211. As illustrated in FIG. 6, the address line (a18) is connected to the connector 5 via a resistor 56. When used as a headset, there is no voltage or current imported into the connector 5. Therefore the address line is considered a binary “O,” and control is provided for the receiver 3 and microphone 4. However, when the connector 5 is connected to the U.S.B. port (70) of a computer 7 (or any other appliance that requires wireless transmission), a voltage of approximately 3V surviving a drop by the connector 5 and the resistance 56 from a 5V voltage output inherent in the general U.S.B. port 70 of the computer 7, is active to supply the current for a binary “1.”

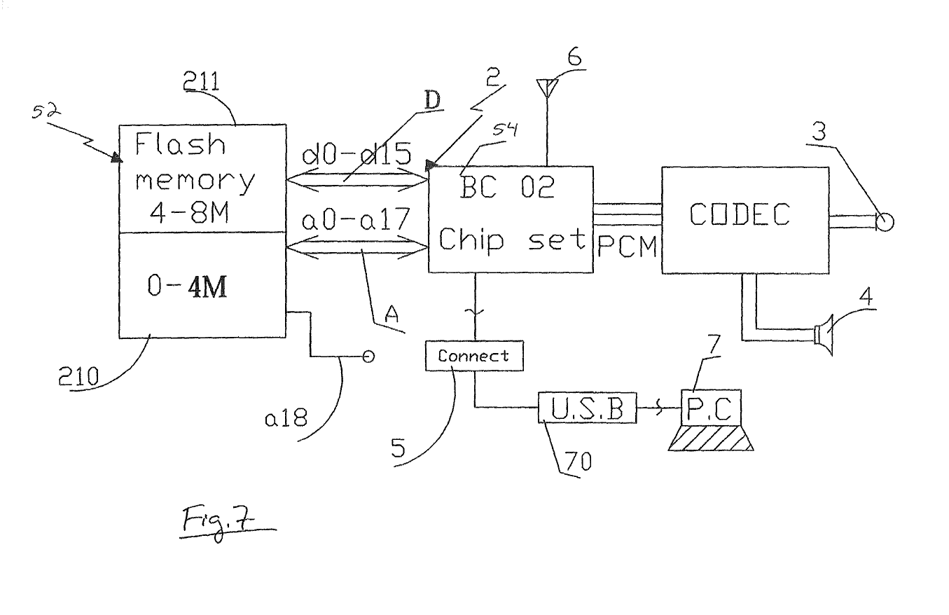

In an alternative embodiment illustrated in FIG. 7, the retractable microphone 4 can be used to control transmission of the binary “0” or “1” to determine which work segment should be used (i.e., a binary “0” is provided when the microphone is opened for use as a headset).

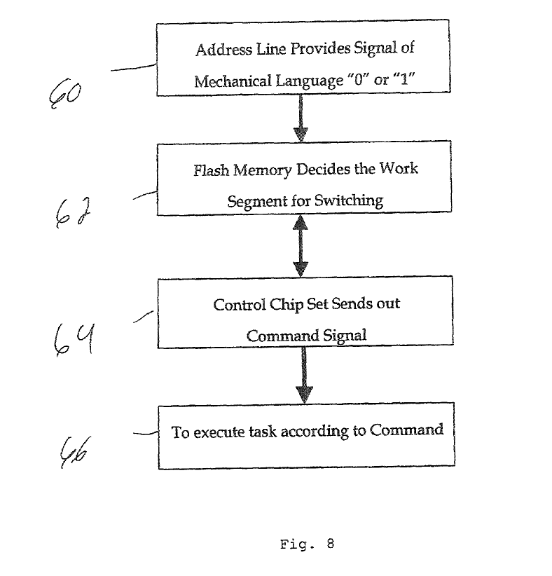

FIG. 8 discloses a flow chart illustrating a portion of the logic for use with the eight megabit memory embodiments of the device. The address line responsible for determining which segment to use is provided with a binary “0” or a “1” as denoted in block 60. The flash memory reads the address line and enables one of the two segments for communication with the control chip as provided in blocks 62 and 64. As shown in block 66, the control chip then performs a task as commanded by the instructions in the selected work segment.

While specific embodiments have been illustrated and described, numerous modifications are possible without departing from the spirit of the invention, and the scope of protection is only limited by the scope of the accompanying claims.

We claim:

1. A wireless communication device comprising:
a headset having an receiver and a microphone, said headset further having a connector for connection to a first apparatus, an antenna, and a control circuit, said control circuit controlling wireless audio transmissions when used in an audio transmission mode and controlling wireless data transmissions when said headset is connected to said first apparatus.

2. The wireless communication device of claim 1 wherein said control circuit comprises an integrated circuit control chip electronically coupled to a memory.

3. The wireless communication device of claim 2 wherein said memory is divided into a first segment for use in audio transmissions, and a second segment for use in data transmissions.

4. The wireless communication device of claim 1 wherein said control circuit comprises an integrated circuit control chip electronically coupled to a first memory for use in audio transmissions and a second memory for use in data transmissions.

5. The wireless communication device of claim 1 wherein said first apparatus is a computer.

6. The wireless communication device of claim 5 wherein said connector connects said headset to the USB port of said computer through a cable.

7. The wireless communication device of claim 6 wherein said device transmits data from said computer to a printer.

8. The wireless communication device of claim 1 wherein said device uses bluetooth protocol for wireless communication.

9. The wireless communication device of claim 1 wherein said headset is in wireless communication with a mobile phone.

10. The wireless communication device of claim 1 wherein said headset is in wireless communication with a stationary phone.

11. The wireless communication device of claim 3 further comprising an address line between said integrated circuit control chip and said memory for selecting one of said first segment and said second segment.

12. A multi-purpose wireless communication device for wireless audio communication and wireless data communication comprising:
a headset having an antenna for wireless communication, said headset further having a connector for connection to a first apparatus for effecting wireless communication between said first apparatus and a second apparatus.

13. The multi-purpose wireless communication device of claim 12 wherein said first apparatus is a computer.

14. The multi-purpose wireless communication device of claim 13 wherein said second apparatus is a printer.

15. The multi-purpose wireless communication device of claim 12 comprising a control circuit located in said headset for controlling wireless communication.

16. The multi-purpose wireless communication device of claim 15 wherein said control circuit includes an integrated circuit control chip connected by address and data lines to a memory chip.

17. The multi-purpose wireless communication device of claim 16 wherein said memory chip is partitioned into a first segment for use with wireless audio transmissions, and a second segment for use with data transmissions when said device is connected to said first apparatus.

18. The multi-purpose wireless communication device of claim 15 wherein said control circuit includes an integrated circuit control chip connected by a first set of address and data lines to a first memory chip, and a second set of address and data lines to a second memory chip, said first memory chip for use with wireless audio communication, and said second memory chip for use with wireless data communication when said device is connected to said first apparatus.

19. The multi-purpose wireless communication device of claim 17 wherein one of said address lines determines which of said first segment and said second segment is used.

20. The multi-purpose wireless communication device of claim 20 wherein connecting said headset to a first apparatus with said connector causes said one of said address lines to use said second segment.

21. A multi-purpose wireless communication device for alternate wireless audio communication and wireless data communication comprising:
a headset case housing an receiver, a microphone and an antenna, said headset case including a connector port for connection via a cable to a computer; and
a control circuit in said case having an integrated circuit control chip connected to flash memory by address and data lines, said flash memory containing information for use in wireless audio communication and wireless data communication.

22. The multi-purpose wireless communication device of claim 21 wherein said device connects to a USB port in said computer.

23. The multi-purpose wireless communication device of claim 22 wherein said device provides wireless communication between said computer and a printer.

24. The multi-purpose wireless communication device of claim 21 wherein said flash memory includes a first segment for use with audio communication and a second segment for use with data communication from said computer.

25. The multi-purpose wireless communication device of claim 21 wherein said flash memory comprises a first flash memory chip for use with audio wireless transmissions, and a second flash memory chip for use with data wireless transmissions, and wherein said address and data lines comprise a first set of address and data lines connecting said first memory chip to said integrated circuit control chip and a second set of address and data lines connecting said second memory chip to said integrated circuit control chip.

26. A multi-purpose wireless communication device comprising:
a headset having an receiver and a microphone,
means for effecting wireless audio communication;
means for connecting said head set to a first apparatus; and,
means for effecting wireless communication between said first apparatus and a second apparatus.

27. The multi-purpose wireless communication device of claim 26 wherein said first apparatus is a computer.

28. The multi-purpose wireless communication device of claim 27 wherein said second apparatus is a printer.

29. The multi-purpose wireless communication device of claim 26 wherein said headset is used for wireless communication with a phone when said headset is not connected to said first apparatus.
